(19) United States
(12) Patent Application Publication
(10) Pub. No.: US 2026/0264164 A1
(43) Pub. Date: Sep. 10, 2026

(54) RESISTANCE WELDING MACHINE AND METHOD OF CONTROLLING RESISTANCE WELDING MACHINE

(71) Applicant: AMADA CO., LTD., Kanagawa (JP)

(72) Inventors: Masayuki ABE, Kanagawa (JP); Takahiro YANO, Kanagawa (JP); Yasuo SAWAI, Kanagawa (JP); Junpei FUKUDA, Kanagawa (JP)

(73) Assignee: AMADA CO., LTD., Kanagawa (JP)

(21) Appl. No.: 19/491,311

(22) PCT Filed: Jun. 19, 2024
(86) PCT No.: PCT/JP2024/022144

§ 371 Date: Dec. 8, 2025

(30) Foreign Application Priority Data
Jul. 3, 2023 (JP) 2023-109217

(51) Int. Cl. B23K 11/24; B23K 11/25

(52) U.S. Cl. CPC B23K 11/241; B23K 11/251

(57) ABSTRACT

A current value and an energization time flowing between first and second electrodes, and a temperature limit of the first electrode during the energization time are set. When the workpiece is welded in accordance with a first set of energization conditions, a controller controls a power supply unit to apply current between the first and second electrodes at the current value for the energization time, in a case where the temperature of the first electrode has not reached the temperature limit within the energization time. The controller controls the power supply unit to shift to welding in accordance with a second set of energization conditions that are set to follow the first set of energization conditions, and controls the power supply unit to stop energizing when the second set of energization conditions are not set, in a case where the temperature of the first electrode has reached the temperature limit.

### TECHNICAL FIELD

The present invention relates to a resistance welding machine and a method of controlling a resistance welding machine.

### BACKGROUND ART

The resistance welding machine as disclosed in Patent Literature 1 is widely used. An electric wire including a plurality of element wires is brought into contact with an electrode to apply pressure to a base material for joining the base material using resistance heat generated by applying an electric current through the base material.

### CITATION LIST

### Patent Literature

[Patent Literature 1] Japanese Unexamined Patent Application Publication No. 2015-49980

### SUMMARY OF INVENTION

When a base material is joined by using a resistance welding machine, it is necessary to prevent the base material or the electrodes from being damaged due to overheating of the electrodes. In particular, when a plurality of base materials are joined in succession by the resistance welding machine, overheating of the electrodes tends to occur. There is a demand for a resistance welding machine and a method of controlling a resistance welding machine, which can prevent base materials or electrodes from being damaged.

A first aspect of one or more embodiments provides a resistance welding machine including: a first electrode and a second electrode between which a base material to be welded is inserted; a pressure application device configured to apply pressure between the first and second electrodes, thereby applying pressure to the base material inserted between the first and second electrodes: a power supply unit configured to provide electrical energy between the first and second electrodes; an infrared radiation thermometer configured to measure temperature of the first electrode; and a controller configured to control the power supply unit, wherein when the base material is welded in accordance with a first set of energization conditions preset as energization conditions including a current value and an energization time flowing between the first and second electrodes when welding the base material, and a temperature limit of the first electrode during the energization time, the controller is configured to control the power supply unit to apply current between the first and second electrodes at the current value for the energization time, in a case where the temperature of the first electrode measured by the infrared radiation thermometer has not reached the temperature limit within the energization time, and the controller is configured to control the power supply unit to shift to welding in accordance with a second set of energization conditions when the second set of energization conditions are set to follow the first set of energization conditions, and to control the power supply unit to stop energizing when the second set of energization conditions are not set, at a point when the temperature of the first electrode has reached the temperature limit, in a case where the temperature of the first electrode measured by the infrared radiation thermometer has reached the temperature limit within the energization time.

A second aspect of one or more embodiments provides a method of controlling a resistance welding machine, including: inserting a base material to be welded between a first electrode and second electrode; applying pressure between the first and second electrodes using a pressure application device, thereby applying pressure to the base material inserted between the first and second electrodes; starting welding of the base material in accordance with a first set of energization conditions preset as energization conditions including a current value and an energization time flowing between the first and second electrodes when welding the base material, and a temperature limit of the first electrode during the energization time; measuring temperature of the first electrode using an infrared radiation thermometer; determining whether or not the temperature of the first electrode measured by the infrared radiation thermometer reaches the temperature limit set under the first set of energization conditions within the energization time set under the first set of energization conditions; controlling the power supply unit to apply current between the first and second electrodes by the current value set under the first set of energization conditions for the energization time, in a case where the temperature of the first electrode has not reached the temperature limit; and controlling the power supply unit to shift to welding in accordance with a second set of energization conditions when the second set of energization conditions are set to follow the first set of energization conditions, and controlling the power supply unit to stop energizing when the second set of energization conditions are not set, at a point when the temperature of the first electrode has reached the temperature limit, in a case where the temperature of the first electrode has reached the temperature limit.

In accordance with the resistance welding machine and the method of controlling the resistance welding machine according to one or more embodiments, it is possible to prevent base materials or electrodes from being damaged.

### BRIEF DESCRIPTION OF DRAWINGS

FIG. 1 is a block diagram illustrating a resistance welding machine according to one or more embodiments.

FIG. 2 is a characteristic diagram illustrating an example of changes in current values and temperature of an electrode when a resistance welding machine according to one or more embodiments joins a workpiece according to one set of energization conditions for which the skip function is selected, showing a case where the temperature of the electrode does not reach a temperature limit within a set energization time.

FIG. 3 is a characteristic diagram illustrating an example of changes in current values and temperature of an electrode when a resistance welding machine according to one or more embodiments joins a workpiece according to one set of energization conditions for which the skip function is selected, showing a case where the temperature of the electrode reaches a temperature limit within a set energization time.

FIG. 4 is a characteristic diagram illustrating an example of changes in current values and temperature of an electrode when a resistance welding machine according to one or more embodiments joins a workpiece according to two sets of energization conditions for which the skip function is selected, showing a case where the temperature of the electrode does not reach a temperature limit within a set energization time.

FIG. 5 is a characteristic diagram illustrating an example of changes in current values and temperature of an electrode when a resistance welding machine according to one or more embodiments joins a workpiece according to two sets of energization conditions for which the skip function is selected, showing a case where the temperature of the electrode reaches a temperature limit within a set energization time.

FIG. 6 is a flowchart illustrating operation of a resistance welding machine according to one or more embodiments, or a method of controlling a resistance welding machine according to one or more embodiments, when a workpiece is welded according to two sets of energization conditions in which a skip function is selected.

FIG. 7 is a characteristic diagram illustrating a first method of controlling a current value to achieve a target temperature under three sets of energization conditions when a resistance welding machine welds a work according to three sets of energization conditions in which a keep function is selected.

FIG. 8 is a characteristic diagram illustrating a second method of controlling a current value to achieve a target temperature under three sets of energization conditions when a resistance welding machine welds a work according to three sets of energization conditions in which a keep function is selected.

FIG. 9 is a characteristic diagram illustrating an example of a change in a current value and an electrode temperature when a resistance welding machine according to one or more embodiments welds a workpiece according to one set of energization conditions in which a skip function is selected and one set of energization conditions in which a keep function is selected.

FIG. 10 is a characteristic diagram illustrating a case where a resistance welding machine according to one or more embodiments determines that an error has occurred in the temperature of the electrode and stops energizing when energizing conditions similar to those in FIG. 4 are set.

FIG. 11 is a partial flowchart illustrating operation of a resistance welding machine according to one or more embodiments, or a method of controlling a resistance welding machine according to one or more embodiments, preferably added to the flowchart illustrated in FIG. 6.

### DESCRIPTION OF EMBODIMENTS

Hereinafter, a resistance welding machine and a method of controlling a resistance welding machine according to one or more embodiments will be described with reference to the accompanying drawings.

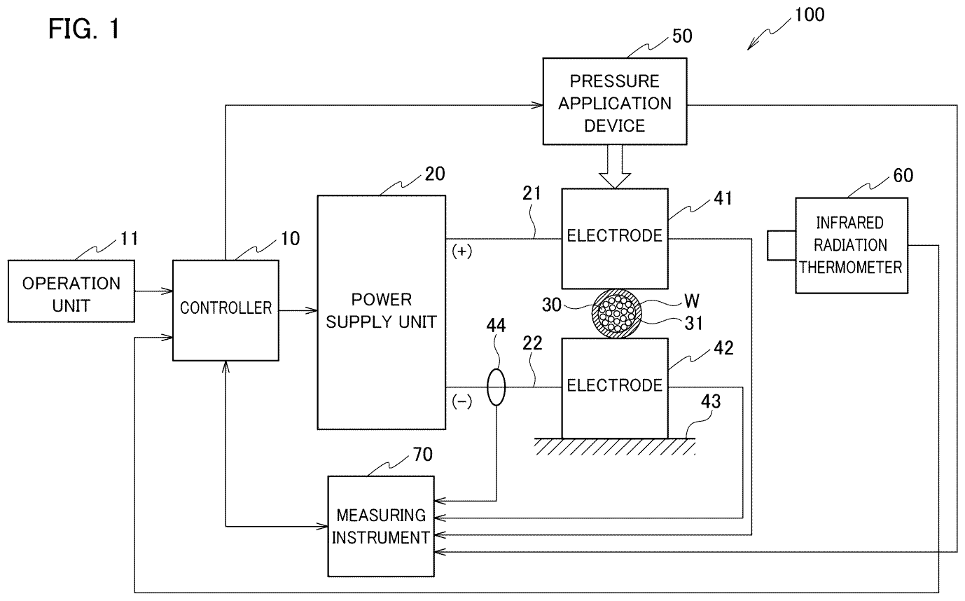

In FIG. 1, a resistance welding machine 100 includes a controller 10, an operation unit 11, a power supply unit 20, an electrode 41 (first electrode), an electrode 42 (second electrode), a pressure application device 50, an infrared radiation thermometer 60, and a measuring instrument 70. As an example of a base material to be welded, a workpiece W is disposed between the electrode 41 and the electrode 42, in which an electric wire 30 including a plurality of element wires is inserted into a cylindrical crimping terminal 31. The electrode 42 is supported by a base 43. The power supply unit 20 and the electrode 41 are connected by a conduction path 21, and the power supply unit 20 and the electrode 42 are connected by a conduction path 22. The controller 10 may be configured by a microprocessor. The power supply unit 20 may be configured by a power supply circuit including a transformer.

The pressure application device 50 applies pressure to the electrode 41 using an air cylinder, for example. The electrode 42 is supported by the base 43, so that the pressure application device 50 can apply pressure to the electrode 41 and the workpiece W inserted between the electrodes 41 and 42, by applying pressure to a space between the electrodes 41 and 42.

In the example illustrated in FIG. 1, the electrode 41 is a positive electrode, and the electrode 42 is a negative electrode. The power supply unit 20 is configured to DC current between the electrode 41 and the electrode 42. The electrode 41 may be a negative electrode and the electrode 42 may be a positive electrode. The power supply unit 20 may be configured to apply AC current between the electrode 41 and the electrode 42. A current sensor 44 made of a toroidal coil is attached to the conduction path 22. The current sensor 44 may be attached to the conduction path 21. A current value detected by the current sensor 44 is supplied to the measuring instrument 70. The electrodes 41 and 42 are connected to the measuring instrument 70 by twisted wires or vinyl-insulated electric wires, and a voltage value between the electrodes 41 and 42 is supplied to the measuring instrument 70.

The infrared radiation thermometer 60 measures the temperature of the electrode 41 by measuring the intensity of infrared radiation emitted from the electrode 41. The infrared radiation thermometer 60 supplies analog temperature data indicating the temperature of the electrode 41 to the controller 10. The controller 10 supplies the input analog temperature data to the measuring instrument 70 as is. The pressure application device 50 is equipped with a load cell for converting a load into an electric signal and a displacement sensor for measuring a displacement. The pressure application device 50 supplies the measuring instrument 70 with an analog value indicating the pressure converted into an electric signal by the load cell. The pressure application device 50 supplies the measuring instrument 70 with a digital value indicating the displacement that is measured by the displacement sensor.

The measuring instrument 70 processes an input current value, a voltage value, analog temperature data, an analog value indicating pressure, and a digital value indicating the displacement into pieces of information, which can be displayed on a display f the measuring instrument 70 and monitored when welding the workpiece W. The measuring instrument 70 instructs the controller 10 to stop welding when the pressure reaches a set value, or when the displacement reaches a set value. When instructed to stop welding, the control part 10 controls the power supply unit 20 to stop energization between the electrodes 41 and 42, and to release pressure by the pressure application device 50.

A user sets energization conditions including the current value, energization time, and temperature limit or target temperature for the controller 10 by using the operation unit 11 when welding the workpiece W. When a temperature limit is set in the controller 10, and the temperature of the electrode 41 reaches the temperature limit within a preset energization time, the controller 10 does not control the power supply unit 20 to energize between the electrode 41 and the electrode 42 for the preset energization time, but is configured to cut off the energization under the energization conditions when the temperature of the electrode 41 reaches the temperature limit. This function of cutting off the energization is referred to as a skip function. When the target temperature is set in the controller 10, the controller 10 controls the power supply unit 20 to maintain the temperature of the electrode 41 within the energization time at the target temperature. This function of maintaining the temperature of the electrode 41 at the target temperature is referred to as a keep function.

The user can select whether to operate the skip function or the keep function under each set of energization conditions. The controller 10 operates the skip function when the temperature limit is set, and operates the keep function when the target temperature is set.

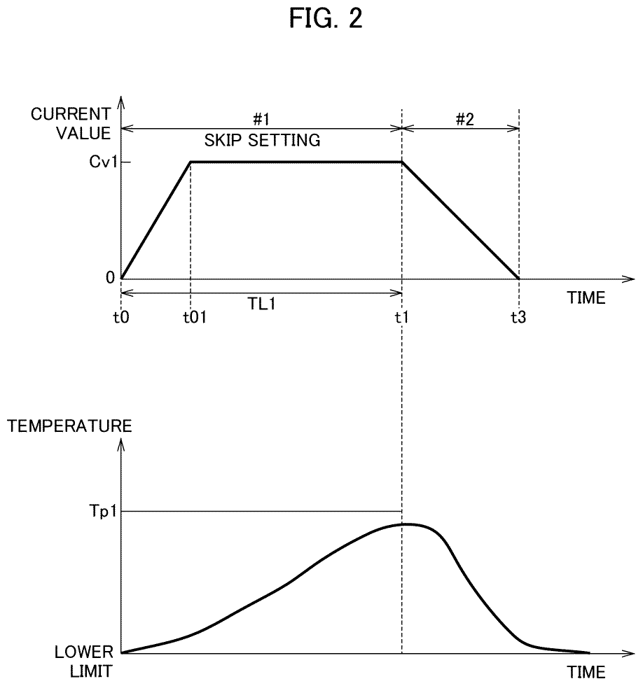

First, a case where the user sets the skip function to operate under different energization conditions will be described. FIG. 2 illustrates an example in which one set of energization conditions (first set of energization conditions) is set to weld the workpiece W during a period #1 from time t0 to time t1, and to stop energization during a period #2 thereafter. The skip function is set to operate during the period #1. In the energization conditions illustrated in FIG. 2, the current value is Cv1 (first value), the energization time from time t0 to time t1 is TL1, and the temperature limit is Tp1. The energization time TL1 includes an upslope time in which the current value linearly increases from 0 to Cv1, from time t0 to time t01, and a time during which the current value is constant at the value of Cv1 from time t01 to time t1.

It is not necessary to provide an upslope time at the beginning of the energization time TL1, and current may flow at the current value Cv1 from time t0. However, if the upslope time is provided at the beginning of the energization time TL1, the workpiece W is slowly heated, and the contact state between the electrodes 41 and 42 and the workpiece W can be stabilized.

The controller 10 controls the pressure application device 50 to apply pressure to the workpiece W, and controls the power supply unit 20 to energize the electrode 41 and the electrode 42 according to the energization conditions illustrated in FIG. 2 while monitoring the temperature of the electrode 41 according to the analog temperature data that is supplied from the infrared radiation thermometer 60. FIG. 2 illustrates a case where the temperature of the electrode 41 does not reach the temperature limit Tp1 within the energization time TL1. The temperature of the electrode 41 increases gradually as the energization continues, but does not reach the temperature limit Tp1 at time t1. After the energization for the energization time TL1, the controller 10 linearly decreases the current value from Cv1 to 0 on the downslope from time t1 to time t3 to stop energizing. The temperature of the electrode 41 decreases non-linearly after time t1.

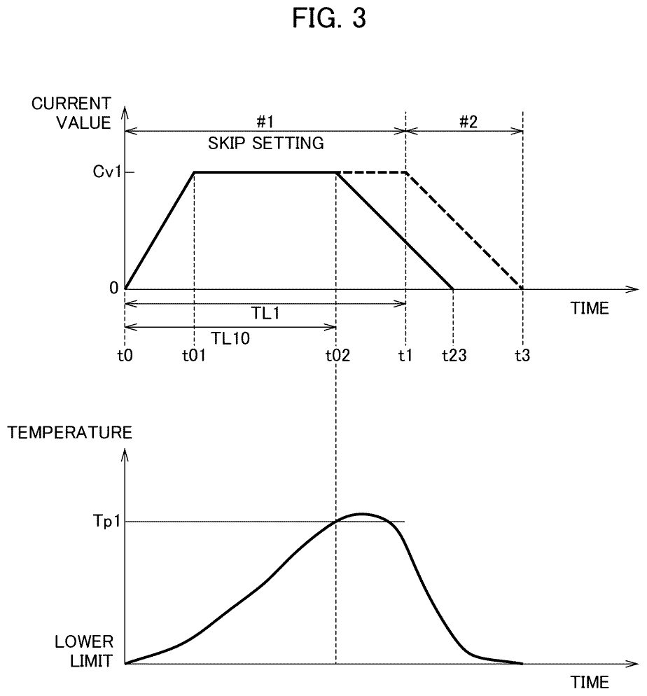

FIG. 3 illustrates a case where the temperature of the electrode 41 reaches the temperature limit Tp1 within the preset energization time TL1. The controller 10 is set to the same energization conditions as in FIG. 2, and the controller 10 energizes between the electrode 41 and the electrode 42 in the same manner as in FIG. 2 to weld the workpiece W.

As illustrated in FIG. 3, the temperature of the electrode 41 reaches the temperature limit Tp1 at time t02. For example, if the infrared radiation thermometer 60 is displaced from a suitable position, the temperature of the electrode 41 cannot be measured accurately, and the temperature of the electrode 41 may rise. In this case, the controller 10 does not energize for the entire energization time TL1, but stops energizing by linearly decreasing the current value from Cv1 to 0 on a downslope at time t02 when the temperature of the electrode 41 reaches the temperature limit Tp1, to time t23. When the controller 10 controls energization as illustrated in FIG. 3, the energization time TL10 is shorter than TL1. The slope of the downslope from time t02 to time t23 is the same as the preset slope of the downslope from time t1 to time t3.

In this way, when the temperature of the electrode 41 reaches the temperature limit Tp1 within the energization time TL1, the controller 10 decreases the current value from Cv1 to 0 after the temperature of the electrode 41 reaches temperature limit Tp1 at time t02, thereby preventing the workpiece W or the electrodes 41 and 42 from being damaged.

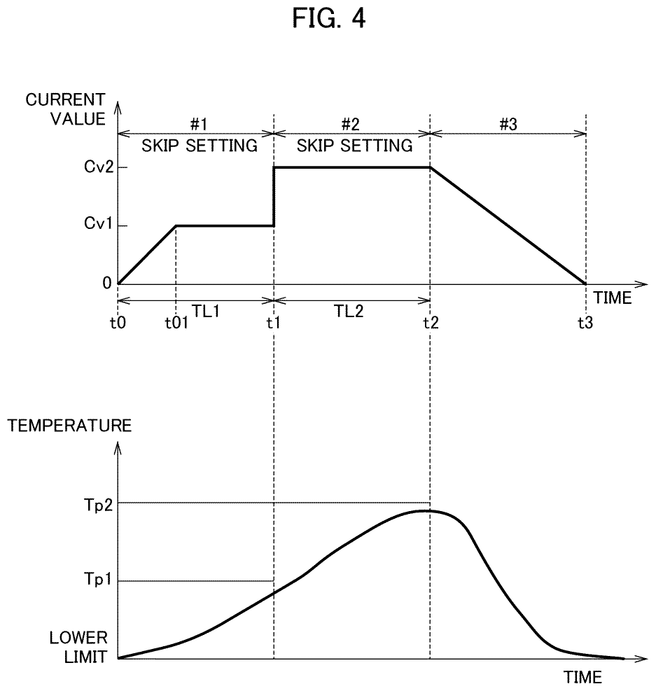

FIG. 4 illustrates an example in which two sets of energization conditions are set to weld the workpiece W, and then to stop energizing. FIG. 4 illustrates an example in which a first set of energization conditions are set for the period #1 from time t0 to time t1, and a second set of energization conditions are set for the period #2 from time t1 to time t2, following the first set of energization conditions, to weld the workpiece W, and then to stop energizing for a period #3. The skip function is set to operate for the periods #1 and #2.

In the first set of energization conditions, the current value is Cv1 (first value), the energization time from time t0 to time t1 is TL1, and the temperature limit is Tp1 (first temperature limit Tp1). In the second set of energization conditions, the current value is Cv2 (second value) that is larger than Cv1; the energization time from time t1 to time t2 is TL2; and the temperature limit is Tp2 (second temperature limit Tp2) that is greater than Tp1. The energization time TL1 and the energization time TL2 may be the same or different.

The energization time TL1 includes an upslope time for linearly increasing the current value from 0 to Cv1 for the period from time t0 to time t01, and a time for keeping the current value constant at Cv1 for the period from time t01 to time t1. The current value Cv1 in FIG. 4 need not be the same as the current value Cv1 in FIGS. 2 and 3. For example, the current value Cv1 in FIG. 4 may be smaller than the current value Cv1 in FIGS. 2 and 3. The energization time TL2 includes a time for keeping the current value constant at Cv2 for the period from time t1 to time t2.

The controller 10 controls the pressure application device 50 to apply pressure to the workpiece W, and controls the power supply unit 20 to energize the electrode 41 and the electrode 42 accordance to the energization conditions illustrated in FIG. 4 while monitoring the temperature of the electrode 41 according to the analog temperature data that is supplied from the infrared radiation thermometer 60. FIG. 4 illustrates a case where the temperature of the electrode 41 neither reaches the first temperature limit Tp1 within the energization time TL1 nor reaches the second temperature limit Tp2 within the energization time TL2. After the energization at the current value Cv2 for the energization time TL2, the controller 10 linearly decreases the current value from Cv2 to 0 on the downslope from time t2 to time t3, and stops energizing. The temperature of the electrode 41 decreases nonlinearly after time t2.

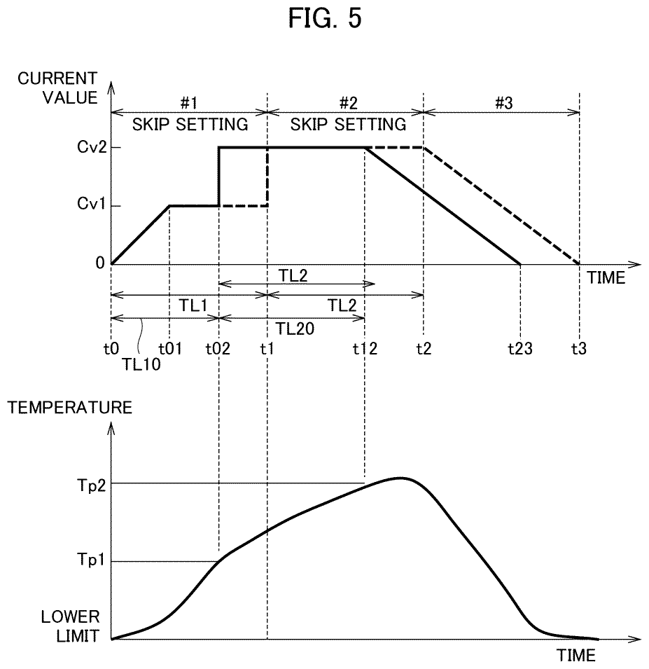

FIG. 5 illustrates a case where the same energization conditions as in FIG. 4 is set for the controller 10. When the controller 10 energizes the electrode 41 and the electrode 42 in the same manner as in FIG. 4 to weld the workpiece W, the temperature of the electrode 41 reaches the first temperature limit Tp1 within a preset energization time TL1, and the temperature of the electrode 41 reaches the second temperature limit Tp2 within a preset energization time TL2.

As illustrated in FIG. 5, the temperature of the electrode 41 reaches the first temperature limit Tp1 at time t02. At this point, the controller 10 not only energizes for the energization time TL1 under the first set of energization conditions but immediately shifts to energization under the second set of energization conditions at time t02 when the temperature of the electrode 41 reaches the first temperature limit Tp1. The energization time TL1 is shortened to an energization time TL10 that includes an upslope time from time t0 to time t01 and a time when the current value from time t01 to time t02 is set constant at the value of Cv1.

After shifting to energization under the second set of energization conditions, the temperature of the electrode 41 reaches the second temperature limit Tp2 at time t12. At this point, the controller 10 does not provide electrical energy for the energization time TL2 at time t02, but linearly decreases the current value from Cv2 to 0 for a period from time t12 to time t23 on a downslope, and then stops energizing when the temperature of the electrode 41 reaches the second temperature limit Tp2. When the controller 10 controls energization as illustrated in FIG. 5, the energization time after shifting to the energization under the second set of energization conditions is shortened to TL20, which is shorter than TL2. The slope of the downslope from time t12 to time t23 is the same as the preset slope of the downslope from time t2 to time t3.

In this way, if the temperature of the electrode 41 reaches the first temperature limit Tp1 within the energization time TL1 when energized under the first set of energization conditions, the controller 10 immediately shifts to the energization under the second set of energization conditions at time t02 when the temperature of the electrode 41 reaches the first temperature limit Tp1, so that the workpiece W or the electrodes 41 and 42 can be prevented from being damaged. Furthermore, in the energization under the second set of energization conditions, when the temperature of the electrode 41 reaches the second temperature limit Tp2 within the energization time TL2, the controller 10 decreases the current value from Cv2 to 0 at time t12 when the temperature of the electrode 41 reaches the second temperature limit Tp2, so that the workpiece W or the electrodes 41 and 42 can be prevented from being damaged.

Although not illustrated, the temperature of the electrode 41 may reach the first temperature limit Tp1 within the energization time TL1 when energizing under the first set of energization conditions, and the temperature of the electrode 41 may not reach the second temperature limit Tp2 within the energization time TL2 when energizing under the second set of energization conditions. In this case, energization for the energization time TL10 from time t0 to time t02 in FIG. 5 is combined with energization at the current value Cv2 for the energization time TL2 at time t02.

In addition, the temperature of the electrode 41 may not reach the first temperature limit Tp1 within the energization time TL1 when energized under the first set of energization conditions, and the temperature of the electrode 41 may reach the second temperature limit Tp2 within the energization time TL2 when energized under the second set of energization conditions. In this case, energization for energization time TL1 from time t0 to time t1 in FIG. 4 is combined with energization for energization time TL20 from time t02 to time t12 as illustrated in FIG. 5.

Although not illustrated, the controller 10 may set three or more sets of energization conditions, and control the power supply unit 20 to weld the workpiece W and then to stop energization.

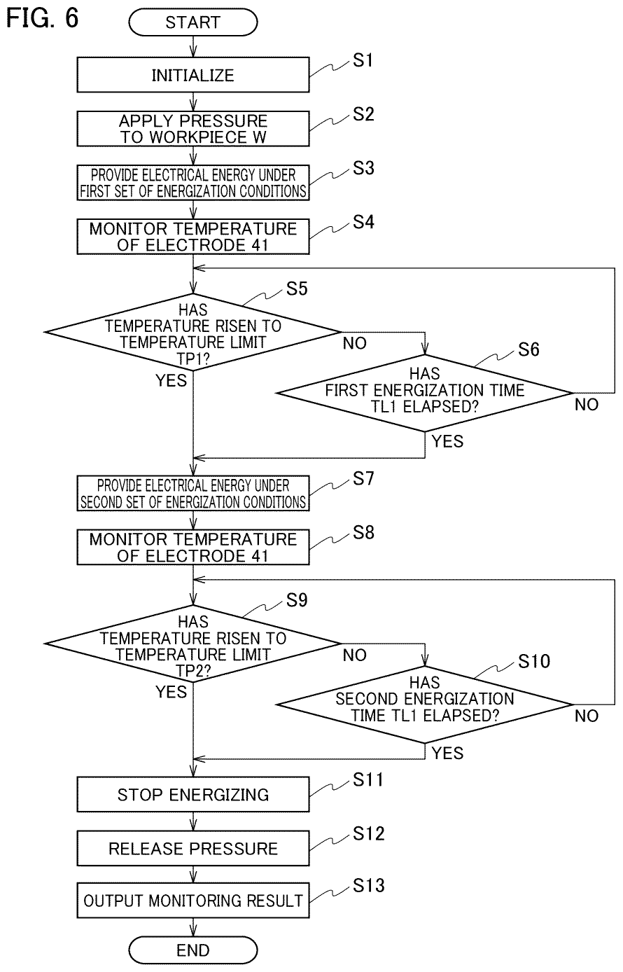

Referring to the flowchart illustrated in FIG. 6, operation of the resistance welding machine 100 or a method of controlling performed by the resistance welding machine 100 will be described. In this case, a user selects the skip function in each set of energization conditions, and set two sets of energization conditions to weld the workpiece W, as an example. Referring to FIG. 6, when the process starts, the controller 10 initializes the resistance welding machine 100 in step S1 to set pressure applied by the pressure application device 50 and the first and second set of energization conditions. The controller 10 controls the pressure application device 50 to apply pressure to the workpiece W using the pressure set in step S2. The controller 10 controls the power supply unit 20 to energize the electrode 41 and the electrode 42 under the first set of energization conditions in step S3.

The controller 10 monitors the temperature of the electrode 41 in step S4 and determines whether the temperature of the electrode 41 has risen to the first temperature limit Tp1 in step S5. When the temperature of the electrode 41 does not rise to the first temperature limit Tp1 (NO), the controller 10 determines in step S6 whether or not the first energization time TL1 has elapsed. When the first energization time TL1 has not elapsed (NO), the controller 10 repeats the processes of steps S5 and S6. When the temperature of the electrode 41 rises to the first temperature limit Tp1 in step S5 (YES), or when the first energization time TL1 has elapsed in step S6 (YES), the controller 10 controls the power supply unit 20 to energize between the electrode 41 and the electrode 42 under the second set of energization conditions in step S7.

Following step S7, the controller 10 monitors the temperature of the electrode 41 in step S8, and determines in step S9 whether or not the temperature of the electrode 41 has risen to the second temperature limit Tp2. If the temperature of the electrode 41 has not risen to the second temperature limit Tp2 (NO), the controller 10 determines in step S10 whether or not the second energization time TL2 has elapsed. If the second energization time TL2 has not elapsed (NO), the controller 10 repeats the processes of steps S9 and S10. When the temperature of the electrode 41 has risen to the second temperature limit Tp2 in step S9 (YES), or when the second energization time TL2 has elapsed in step S10 (YES), the controller 10 reduces the current value flowing between the electrode 41 and the electrode 42 in step S11 to stop energizing.

In step S12, the controller 10 controls the pressure application device 50 to release pressure to the workpiece W. In step S13, the controller 10 controls the measuring instrument 70 to output a monitoring result during welding of the workpiece W. Outputting the monitoring result means displaying the monitoring result on a display unit included in the measuring instrument 70, for example.

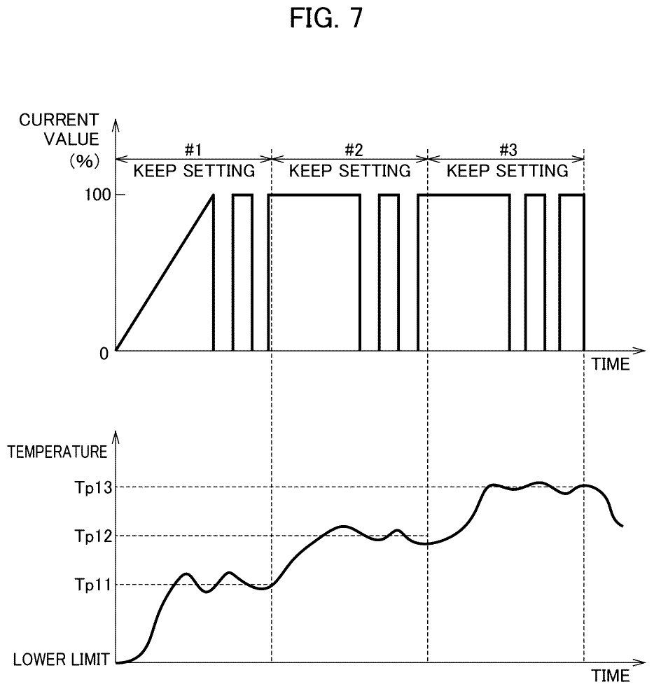

Next, a case where the user sets the keep function to operate under each set of energization conditions will be described. FIG. 7 illustrates a first method of controlling the current value for achieving target temperatures Tp11, Tp12, and Tp13 under three sets of energization conditions. The user selects the keep function under each set of the energization conditions, and sets the three sets of energization conditions for welding the workpiece W during periods #1 to #3. The target temperature Tp11 is lower than the first temperature limit Tp1, and the target temperature Tp12 is lower than the second temperature limit Tp2. The target temperature Tp13 is lower than the third temperature limit set under the third energization conditions for setting a current value larger than the current value Cv2.

As illustrated in FIG. 7, the controller 10 controls the power supply unit 20 so that the temperatures of the electrode 41 under the three sets of energization conditions are approximately the target temperatures Tp11, Tp12, and Tp13 by intermittently reducing the current value to 0% and adjusting the time for setting the current value to 0%.

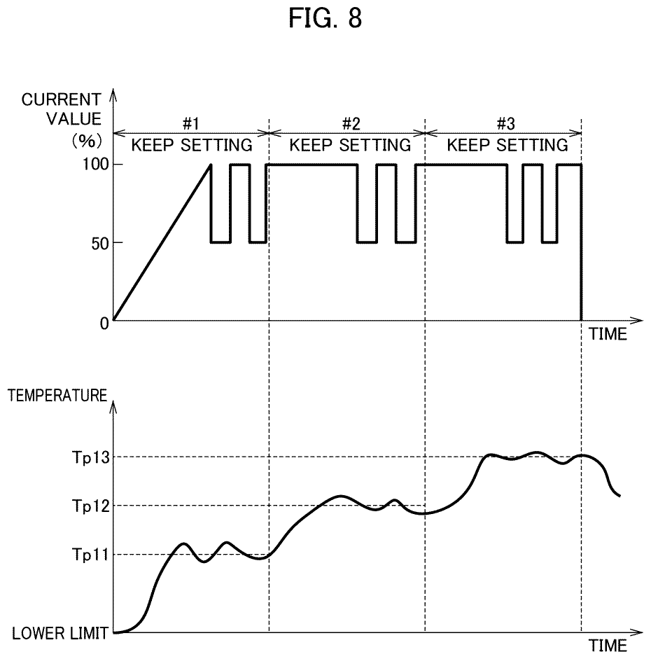

As illustrated in FIG. 8, the controller 10 may control the power supply unit 20 so that the temperatures of the electrode 41 under the three sets of energization conditions are approximately the target temperatures Tp11, Tp12, and Tp13 by intermittently reducing the current value to 50% and adjusting the time for reducing the current value to 50%. The reduction of the current value is not limited to 50%, but may be any amount of reduction exceeding 0% and less than 100%.

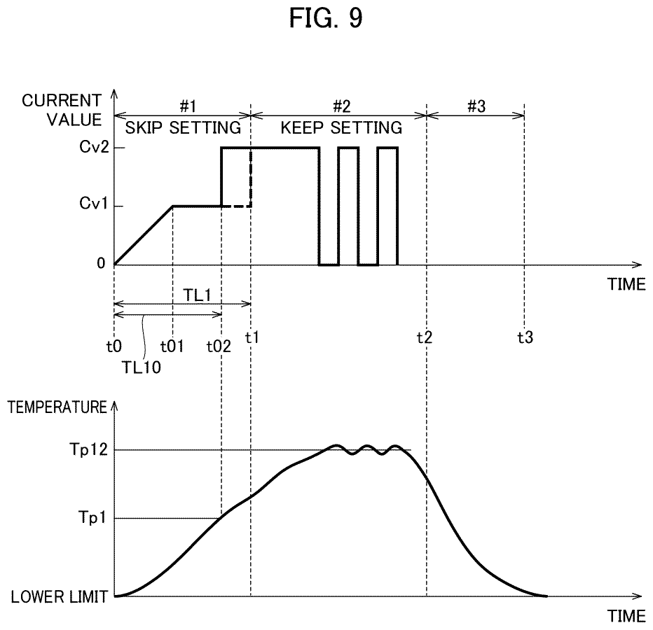

The user may set the skip function to operate under a certain set of energization conditions, and may set the keep function to operate under another set of energization conditions. FIG. 9 illustrates an example in which the workpiece W is welded by setting two sets of energization conditions, and then the energization is stopped.

In FIG. 9, the first set of energization conditions are set to operate the skip function during the period #1 from time t0 to time t1, and the second set of energization conditions are set to operate the keep function during the period #2 from time t1 to time t2. In FIG. 9, energizing is set to stop immediately without providing a downslope during the period #3.

As in FIG. 5, FIG. 9 illustrates a case where the temperature of the electrode 41 reaches the first temperature limit Tp1 within the energization time TL1. The controller 10 immediately shifts to energization under the second set of energization conditions at time t02 when the temperature of the electrode 41 reaches the first temperature limit Tp1. During the period #2, the controller 10 controls the current value to maintain the temperature of the electrode 41 at the target temperature Tp12.

In this way, the skip function and the keep function can be arbitrarily selected under each set of energization conditions.

For some reason, the temperature of the electrode 41 may not increase even after a predetermined time elapses when measured by the infrared radiation thermometer 60 after starting energizing. Preferably, the controller 10 monitors the temperature of the electrode 41 based on the input analog temperature data, and determines that an error has occurred in the measured temperature when it is assumed that the infrared radiation thermometer 60 does not correctly measure the temperature of the electrode 41.

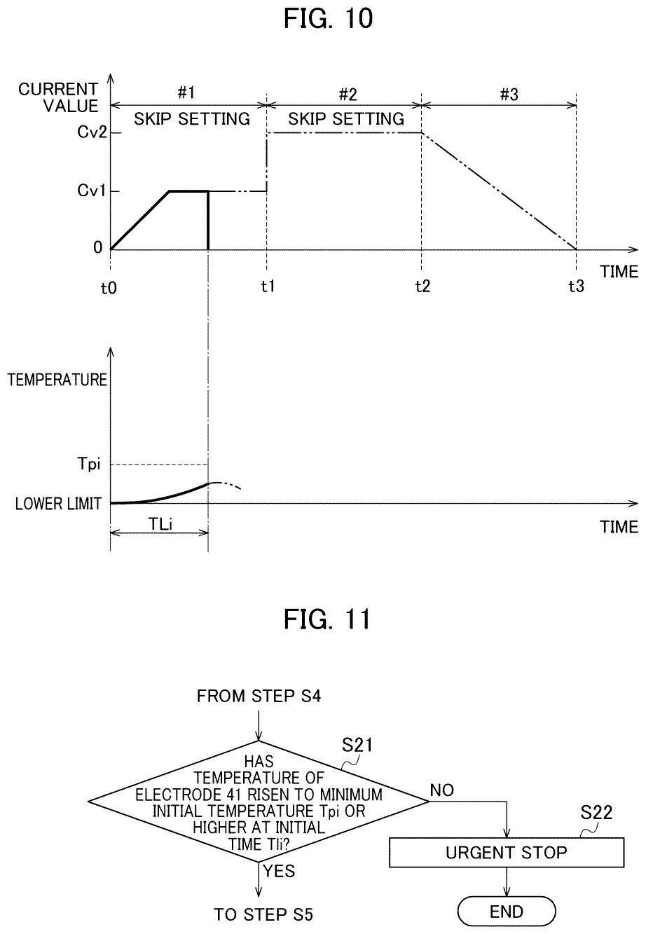

As illustrated in FIG. 10, the same energization conditions as that in FIG. 4 are set as an example. In the controller 10, the minimum initial temperature Tpi is set at the time when a predetermined initial time TLi has elapsed from the time to of the start of energization. If the temperature of the electrode 41 indicated by the analog temperature data does not reach the minimum initial temperature Tpi when the initial time TLi has elapsed, the controller 10 determines that an error has occurred in the temperature of the electrode 41. Since the infrared radiation thermometer 60 may not correctly measure the temperature of the electrode 41, the temperature at the time when the initial time TLi shown in FIG. 10 has elapsed may not correctly indicate the actual temperature of the electrode 41.

Therefore, when the controller 10 determines that an error has occurred in the temperature of the electrode 41, it controls the power supply unit 20 to immediately stop providing electrical energy between the electrode 41 and the electrode 42. Furthermore, the controller 10 controls the pressure application device 50 to immediately release pressure to the workpiece W. Thus, it is possible to prevent the workpiece W and the electrodes 41 and 42 from being damaged. Furthermore, the controller 10 may determine that an error has occurred when the temperature of the electrode 41 becomes abnormally high, and control the power supply unit 20 and the pressure application device 50 to stop providing electrical energy between the electrode 41 and the electrode 42, and to release pressure to the workpiece W.

As illustrated in FIG. 11, the flowchart in FIG. 6 preferably includes steps S21 and S22. In FIG. 11, the controller 10 determines whether or not the temperature of the electrode 41 rises to a minimum initial temperature Tpi or higher at an initial time TLi in step S21 following step S4 in FIG. 6. When the temperature of the electrode 41 rises above the minimum initial temperature Tpi at the initial time TLi (YES), the controller 10 moves the process to step S5 in FIG. 6. If the temperature of the electrode 41 does not rise above the minimum initial temperature Tpi at the initial time TLi (NO), the controller 10 urgently stops providing electrical energy between the electrode 41 and the electrode 42 and releases pressure to the workpiece Wat step 22, and ends the process.

The present invention is not limited to one or more embodiments described above, and various modifications are possible without departing from the scope of the present invention.

This application claims priority based on Japanese Patent Application No. 2023-109217 filed with the Japan Patent Office on Jul. 3, 2023, the entire contents of which are incorporated herein by reference.

1. A resistance welding machine comprising:
a first electrode and a second electrode between which a base material to be welded is inserted;
a pressure application device configured to apply pressure between the first and second electrodes, thereby applying pressure to the base material inserted between the first and second electrodes:
a power supply unit configured to provide electrical energy between the first and second electrodes;
an infrared radiation thermometer configured to measure temperature of the first electrode; and
a controller configured to control the power supply unit, wherein
when the base material is welded in accordance with a first set of energization conditions preset as energization conditions including a current value and an energization time flowing between the first and second electrodes when welding the base material, and a temperature limit of the first electrode during the energization time,
the controller is configured to control the power supply unit to apply current between the first and second electrodes at the current value for the energization time, in a case where the temperature of the first electrode measured by the infrared radiation thermometer has not reached the temperature limit within the energization time, and
the controller is configured to control the power supply unit to shift to welding in accordance with a second set of energization conditions when the second set of energization conditions are set to follow the first set of energization conditions, and to control the power supply unit to stop energizing when the second set of energization conditions are not set, at a point when the temperature of the first electrode has reached the temperature limit, in a case where the temperature of the first electrode measured by the infrared radiation thermometer has reached the temperature limit within the energization time.

2. The resistance welding machine according to claim 1, wherein the controller is configured to control the power supply unit to stop providing electrical energy between the first and second electrodes, and to control the pressure application device to release pressure between the first and second electrodes, when the controller determines that an error has occurred in the temperature of the first electrode that is measured by the infrared radiation thermometer.

3. The resistance welding machine according to claim 2, wherein the controller is configured to determine that an error has occurred in the temperature of the first electrode when the temperature of the first electrode has not reached a minimum initial temperature, at a point when a predetermined initial time elapses after starting providing electrical energy between the first and second electrodes.

4. A method of controlling a resistance welding machine, comprising:
inserting a base material to be welded between a first electrode and second electrode;
applying pressure between the first and second electrodes using a pressure application device, thereby applying pressure to the base material inserted between the first and second electrodes;
starting welding of the base material in accordance with a first set of energization conditions preset as energization conditions including a current value and an energization time flowing between the first and second electrodes when welding the base material, and a temperature limit of the first electrode during the energization time;
measuring temperature of the first electrode using an infrared radiation thermometer;
determining whether or not the temperature of the first electrode measured by the infrared radiation thermometer reaches the temperature limit set under the first set of energization conditions within the energization time set under the first set of energization conditions;
controlling the power supply unit to apply current between the first and second electrodes by the current value set under the first set of energization conditions for the energization time, in a case where the temperature of the first electrode has not reached the temperature limit; and
controlling the power supply unit to shift to welding in accordance with a second set of energization conditions when the second set of energization conditions are set to follow the first set of energization conditions, and controlling the power supply unit to stop energizing when the second set of energization conditions are not set, at a point when the temperature of the first electrode has reached the temperature limit, in a case where the temperature of the first electrode has reached the temperature limit.

5. The method of controlling a resistance welding machine according to claim 4, further comprising:
controlling the power supply unit to stop providing electrical energy between the first and second electrodes, and controlling the pressure application device to release pressure between the first and second electrodes, when it is determined that an error has occurred in the temperature of the first electrode measured by the infrared radiation thermometer.

6. The method of controlling a resistance welding machine according to claim 5, further comprising determining that an error has occurred in the temperature of the first electrode when the temperature of the first electrode has not reached a minimum initial temperature at a point when a predetermined initial time elapses after starting providing electrical energy between the first and second electrodes.
